(19) United States
(12) Patent Application Publication
(10) Pub. No.: US 2007/0256033 A1
(43) Pub. Date: Nov. 1, 2007

(54) SYSTEM AND METHOD FOR FLAGGING INFORMATION CONTENT

(75) Inventor: John A. Hiler, New York, NY (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: Xanga.com, Inc., New York, NY (US)

(21) Appl. No.: 11/741,643

(22) Filed: Apr. 27, 2007

Related U.S. Application Data
(60) Provisional application No. 60/795,583, filed on Apr. 28, 2006.

(51) Int. Cl. G06F 3/048

(52) U.S. Cl. 715/860

(57) ABSTRACT

The present invention is directed to a decentralized, fraud-resistant flagging system for information content, such as World Wide Web or Internet content. The system includes an information content display module for displaying the information content and an associated plurality of flagging levels to users. The plurality of flagging levels are configured for flagging the information content by the users. The system includes a flagging generation module, in communication with the information content display module, for receiving flags assigned by the users to the information content in accordance with the plurality of flagging levels, for assigning a weight to each user flagging in accordance with an accuracy of the user flagging, and for prioritizing flagged information content for review in accordance with a volume of flags assigned to the information content and the flagging weight of each user flagging.

The present application claims priority under 35 U.S.C. § 119(e) to U.S. Provisional Application No. 60/795,583, filed on Apr. 28, 2006, the entire contents of which are hereby incorporated by reference herein.

### BACKGROUND

1. Field of the Invention

The present invention relates to content flagging systems. More particularly, the present invention relates to a decentralized, fraud-resistant system and method for flagging information content, such as Internet or World Wide Web content, that meets previously-defined characteristics.

2. Background Information

There has been an explosion in the amount of User-Generated Content (UGC) being created, as more and more media is created directly by consumers, including weblogs, photoblogs, video blogs, social network profiles, podcasts, and the like. It is exceedingly difficult to police such a massive amount of content, a problem that will only grow over time as the UGC industry matures.

Many if not most UGC sites, such as, for example, Xanga.com, do not pre-screen content, and, instead, rely on their users to report content that may violate their rules of member conduct or other content guidelines or restrictions. UGC sites can hire moderators to do nothing but review content. Unfortunately, hired human moderators fail to solve the problem for several reasons. For example, fulltime moderators are very expensive. Furthermore, such moderators cannot respond quickly enough to police content that potentially violates a website's rules of member conduct or other content guidelines or restrictions. In addition, it is difficult to “scale up” and quickly hire as many moderators as needed, given the massive amounts of content that need to be policed. As a result, content that violates a website's rules of member conduct or guidelines or restrictions can be found on most if not every UGC site.

Decentralized flagging systems on community websites, such as, for example, Craigslist and YouTube, have begun to address the issue of cheaply identifying content that violates a website's rules of member conduct or other like content guidelines or restrictions. However, such flagging systems can easily be abused by fraudulent flagging. According to the Craigslist website, a small percentage of all content flagged and deleted from their system is actually within their terms of use, and, therefore, has been erroneously and fraudulently deleted.

Such occurrences raise a critical question regarding fraud in a decentralized flagging system. In particular, how can flaggers be prevented from fraudulently flagging content for review and/or deletion? Resolving the tension between decentralization and fraud has so far proved to be a difficult, if not intractable, problem. As a result, no fraud-resistant system of flagging content has yet emerged for the UGC industry.

### SUMMARY OF THE INVENTION

A decentralized, fraud-resistant system and method for flagging information content, such as Internet or World Wide Web content, is disclosed. In accordance with exemplary embodiments of the present invention, according to a first aspect of the present invention, a system for flagging information content includes an information content display module. The information content display module is configured to display the information content and an associated plurality of flagging levels to users. The plurality of flagging levels are configured for flagging the information content by the users. The system includes a flagging generation module in communication with the information content display module. The flagging generation module is configured to receive flags assigned by the users to the information content in accordance with the plurality of flagging levels. The flagging generation module is configured to assign a weight to each user flagging in accordance with an accuracy of the user flagging. The flagging generation module is configured to prioritize flagged information content for review in accordance with a volume of flags assigned to the information content and the flagging weight of each user flagging.

According to the first aspect, each flag submitted by each user can be associated with identifying information of the user. The system can include an identification information module in communication with the flagging generation module. The identification information module can be configured to capture the identifying information associated with the user upon flagging of the information content. The flagging generation module can be configured to group flags for common information content. The flagging generation module can be configured to identify information content using information contained in the network link of the information content. The flagging generation module can be configured to parse the network link of the information content to identify the information content. The user can assign at least one flag to the information content. The current flag assignment to the information content by the user can replace the previous flag assignment to the same information content by the same user. The flagging generation module can be configured to ignore the user flagging of information content of the user when prioritizing flagged information content for review. The flagging generation module can be configured to utilize a combination of flagging information as a single flag when prioritizing flagged information content for review. For example, the flagging information can comprise at least one of a flag designation, a network link of the information content being flagged, and a network address of the user performing the flagging.

According to the first aspect, the information content display module can be configured to aggregate and display prioritized flagged information content in a user interface to facilitate review. The system can include a flagging review module in communication with the flagging generation module. The flagging review module can be configured to review the prioritized flagged information content to determine the accuracy of the flags assigned by the users. The flagging review module can be configured to designate the flag with a first designation upon determination that the information content is flagged correctly. The flagging review module can be configured to designate the flag with a second designation upon determination that the information content is flagged incorrectly. The flagging generation module can be configured to increase the flagging weight of the user upon determination that the user correctly flagged the information content. The flagging weight can be increased by a first amount for known users and increased by a second amount for anonymous users. The flagging generation module can be configured to decrease the flagging weight of the user upon determination that the user incorrectly flagged the information content. The flagging weight can be decreased by a first amount for known users and decreased by a second amount for anonymous users. A change in the flagging weight of the user can be configured to cause the flagging generation module to re-prioritize information content not yet reviewed that has been flagged by the user. The flagging generation module can be configured to apply a predetermined function to the flagging weight of each user when prioritizing information content for review. The system can include a fraud determination module in communication with the flagging generation module. The fraud determination module can be configured to screen each user flagging for fraud in accordance with the accuracy of the user flagging. The flagging generation module can be configured to decrease the weight assigned to the user flagging when the user flagging is determined to be fraudulent by the fraud determination module. According to an exemplary embodiment of the first aspect, the information content can comprise, for example, World Wide Web content or any suitable type of information content.

According to a second aspect of the present invention, a method of flagging information content includes the steps of: a.) displaying the information content and an associated plurality of flagging levels to users; b.) flagging the information content by assigning one of the plurality of flagging levels to the information content by the users; c.) assigning a weight to each user flagging in accordance with an accuracy of the user flagging; and d.) prioritizing flagged information content for review in accordance with a volume of flags assigned to the information content and the flagging weight of each user flagging.

According to the second aspect, each flag submitted by each user can be associated with identifying information of the user. The method can include one or more of the following steps of: e.) capturing the identifying information associated with the user upon flagging of the information content; f.) grouping flags for common information content; g.) identifying information content using information contained in the network link of the information content; and h.) parsing the network link of the information content to identify the information content. The user can assign at least one flag to the information content. The current flag assignment to the information content by the user can replace the previous flag assignment to the same information content by the same user. The method can include one or more of the following steps: i.) ignoring the user flagging of information content of the user when prioritizing flagged information content for review; and j.) utilizing a combination of flagging information as a single flag when prioritizing flagged information content for review. For example, the flagging information can comprise at least one of a flag designation, a network link of the information content being flagged, and a network address of the user performing the flagging.

According to the second aspect, the method can include one or more of the following steps: k.) displaying prioritized flagged information content in a user interface to facilitate review; l.) reviewing the prioritized flagged information content to determine the accuracy of the flags assigned by the users; m.) designating the flag with a first designation upon determination that the information content is flagged correctly; n.) designating the flag with a second designation upon determination that the information content is flagged incorrectly; and o.) increasing the flagging weight of the user upon determination that the user correctly flagged the information content. The flagging weight can be increased by a first amount for known users and increased by a second amount for anonymous users. The method can include the step of: p.) decreasing the flagging weight of the user upon determination that the user incorrectly flagged the information content. The flagging weight can be decreased by a first amount for known users and decreased by a second amount for anonymous users. A change in the flagging weight of the user can cause a re-prioritization of information content not yet reviewed that has been flagged by the user. The method can include one or more of the following steps: q.) applying a predetermined function to the flagging weight of each user when prioritizing information content for review; r.) screening each user flagging for fraud in accordance with the accuracy of the user flagging; and s.) decreasing the weight assigned to the user flagging when the user flagging is determined to be fraudulent. According to an exemplary embodiment of the second aspect, the information content can comprise, for example, World Wide Web content or any suitable type of information content.

According to a third aspect of the present invention, a decentralized system for flagging information content includes a server computer and a plurality of client computers in communication with the server computer. The server computer is configured to cause the display, on at least one of the plurality of client computers, of the information content and a plurality of flagging levels for flagging the information content by users. Users on client computers assign one of the plurality of flagging levels to the information content. The server computer is configured to assign a weight to each user flagging in accordance with an accuracy of the user flagging. The server computer is configured to prioritize flagged information content for review in accordance with a volume of flags assigned to the information content and the flagging weight of each user flagging.

According to the third aspect, each flag submitted by each user can be associated with identifying information of the user. The server computer can be configured to capture the identifying information associated with the user upon flagging of the information content. The server computer can be configured to group flags for common information content. The server computer can be configured to identify information content using information contained in the network link of the information content. The server computer can be configured to parse the network link of the information content to identify the information content. The user can assign at least one flag to the information content. The current flag assignment to the information content by the user can replace the previous flag assignment to the same information content by the same user. The server computer can be configured to ignore the user flagging of information content of the user when prioritizing flagged information content for review. The server computer can be configured to utilize a combination of flagging information as a single flag when prioritizing flagged information content for review. For example, the flagging information can comprise at least one of a flag designation, a network link of the information content being flagged, and a network address of the user performing the flagging.

According to the third aspect, the server computer can be configured to aggregate prioritized flagged information content for display via a user interface of the client computers to facilitate review. The server computer can be configured to review the prioritized flagged information content to determine the accuracy of the flags assigned by the users. The server computer can be configured to designate the flag with a first designation upon determination that the information content is flagged correctly. The server computer can be configured to designate the flag with a second designation upon determination that the information content is flagged incorrectly. The server computer can be configured to increase the flagging weight of the user upon determination that the user correctly flagged the information content. The flagging weight can be increased by a first amount for known users and increased by a second amount for anonymous users. The server computer can be configured to decrease the flagging weight of the user upon determination that the user incorrectly flagged the information content. The flagging weight can be decreased by a first amount for known users and decreased by a second amount for anonymous users. A change in the flagging weight of the user can be configured to cause the server computer to re-prioritize information content not yet reviewed that has been flagged by the user. The server computer can be configured to apply a predetermined function to the flagging weight of each user when prioritizing information content for review. The server computer can be configured to screen each user flagging for fraud in accordance with the accuracy of the user flagging. The server computer can be configured to decrease the weight assigned to the user flagging when the user flagging is determined to be fraudulent. According to an exemplary embodiment of the third aspect, the information content can comprise, for example, World Wide Web content or any suitable type of information content.

According to a fourth aspect of the present invention, a system for flagging information content includes means for displaying information content. The information content displaying means is configured to display information content and an associated plurality of flagging levels to users. The plurality of flagging levels are configured for flagging the information content by the users. The system includes means for generating flagging in communication with the information content displaying means. The flagging generating means is configured to receive flags assigned by the users to the information content in accordance with the plurality of flagging levels. The flagging generating means is configured to assign a weight to each user flagging in accordance with an accuracy of the user flagging. The flagging generating means is configured to prioritize flagged information content for review in accordance with a volume of flags assigned to the information content and the flagging weight of each user flagging.

According to the fourth aspect, each flag submitted by each user can be associated with identifying information of the user. The system can include means for capturing identification information in communication with the flagging generating means. The identification information capturing means can be configured to capture the identifying information associated with the user upon flagging of the information content. The flagging generating means can be configured to group flags for common information content. The flagging generating means can be configured to identify information content using information contained in the network link of the information content. The flagging generating means can be configured to parse the network link of the information content to identify the information content. The user can assign at least one flag to the information content The current flag assignment to the information content by the user can replace the previous flag assignment to the same information content by the same user. The flagging generating means can be configured to ignore the user flagging of information content of the user when prioritizing flagged information content for review. The flagging generating means can be configured to utilize a combination of flagging information as a single flag when prioritizing flagged information content for review. For example, the flagging information can comprise at least one of a flag designation, a network link of the information content being flagged, and a network address of the user performing the flagging.

According to the fourth aspect, the information content displaying means can be configured to aggregate and display prioritized flagged information content in a user interface to facilitate review. The system can include means for reviewing flagging in communication with the flagging generating means. The flagging reviewing means can be configured to review the prioritized flagged information content to determine the accuracy of the flags assigned by the users. The flagging reviewing means can be configured to designate the flag with a first designation upon determination that the information content is flagged correctly. The flagging reviewing means can be configured to designate the flag with a second designation upon determination that the information content is flagged incorrectly. The flagging generating means can be configured to increase the flagging weight of the user upon determination that the user correctly flagged the information content. The flagging weight can be increased by a first amount for known users and increased by a second amount for anonymous users. The flagging generating means can be configured to decrease the flagging weight of the user upon determination that the user incorrectly flagged the information content. The flagging weight can be decreased by a first amount for known users and decreased by a second amount for anonymous users. A change in the flagging weight of the user can be configured to cause the flagging generating means to re-prioritize information content not yet reviewed that has been flagged by the user. The flagging generating means can be configured to apply a predetermined function to the flagging weight of each user when prioritizing information content for review. The system can include means for determining fraud in communication with the flagging generating means. The fraud determining means can be configured to screen each user flagging for fraud in accordance with the accuracy of the user flagging. The flagging generating means can be configured to decrease the weight assigned to the user flagging when the user flagging is determined to be fraudulent by the fraud determining means. According to an exemplary embodiment of the fourth aspect, the information content can comprise, for example, World Wide Web content or any suitable type of information content.

According to a fifth aspect of the present invention, a computer-readable medium contains a computer program for flagging information content. The computer program performs the steps of: a.) causing the display of the information content and an associated plurality of flagging levels to users; b.) receiving flagging information from users for flagging the information content, wherein the flagging information is generated by the users assigning one of the plurality of flagging levels to the information content; c.) assigning a weight to each user flagging in accordance with an accuracy of the user flagging; and d.) prioritizing flagged information content for review in accordance with a volume of flags assigned to the information content and the flagging weight of each user flagging.

According to the fifth aspect, each flag submitted by each user can be associated with identifying information of the user. The computer program can perform one or more of the following steps: e.) capturing the identifying information associated with the user upon flagging of the information content; f.) grouping flags for common information content; g.) identifying information content using information contained in the network link of the information content; and h.) parsing the network link of the information content to identify the information content. The user can assign at least one flag to the information content. The current flag assignment to the information content by the user can replace a previous flag assignment to the same information content by the same user. The computer program can perform one or more of the following steps: i.) ignoring the user flagging of information content of the user when prioritizing flagged information content for review; and j.) utilizing a combination of flagging information as a single flag when prioritizing flagged information content for review. For example, the flagging information can comprise at least one of a flag designation, a network link of the information content being flagged, and a network address of the user performing the flagging.

According to the fifth aspect, the computer program can perform one or more of the following steps: k.) causing the display of the prioritized flagged information content in a user interface to facilitate review; l.) reviewing the prioritized flagged information content to determine the accuracy of the flags assigned by the users; m.) designating the flag with a first designation upon determination that the information content is flagged correctly; n.) designating the flag with a second designation upon determination that the information content is flagged incorrectly; and o.) increasing the flagging weight of the user upon determination that the user correctly flagged the information content. The flagging weight can be increased by a first amount for known users and increased by a second amount for anonymous users. The computer program can perform the step of: p.) decreasing the flagging weight of the user upon determination that the user incorrectly flagged the information content. The flagging weight can be decreased by a first amount for known users and decreased by a second amount for anonymous users. A change in the flagging weight of the user can cause a re-prioritization of information content not yet reviewed that has been flagged by the user. The computer program can perform one or more of the following steps: q.) applying a predetermined function to the flagging weight of each user when prioritizing information content for review; r.) screening each user flagging for fraud in accordance with the accuracy of the user flagging; and s.) decreasing the weight assigned to the user flagging when the user flagging is determined to be fraudulent. According to an exemplary embodiment of the fifth aspect, the information content can comprise, for example, World Wide Web content or any suitable type of information content.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a block diagram illustrating a system for flagging information content, in accordance with an exemplary embodiment of the present invention.

FIG. 2 is a block diagram illustrating a decentralized system for flagging information content, in accordance with an alternative exemplary embodiment of the present invention.

FIG. 3 is a flowchart illustrating steps for flagging information content, in accordance with an exemplary embodiment of the present invention.

### DETAILED DESCRIPTION OF THE PREFERRED EMBODIMENTS

Exemplary embodiments of the present invention are directed to a fraud-resistant and decentralized system and method for flagging information content. The flagging system of the present invention can be used, for example, as a self-regulatory system for flagging any suitable information content, such as, for example, World Wide Web or Internet content or the like. The flagging system according to exemplary embodiments is configured such that any user can flag any suitable individual or collective information content (e.g., a website page or any information items contained within that website page) for specific reasons (e.g., specific violations of a websites rules of member conduct). Flagged items are prioritized for review based on the volume of flags and the flagging weight of each individual flagger. The system is fraud-resistant, so that fraudulent flaggers can be quickly detected and given a weight so low as to be effectively ignored.

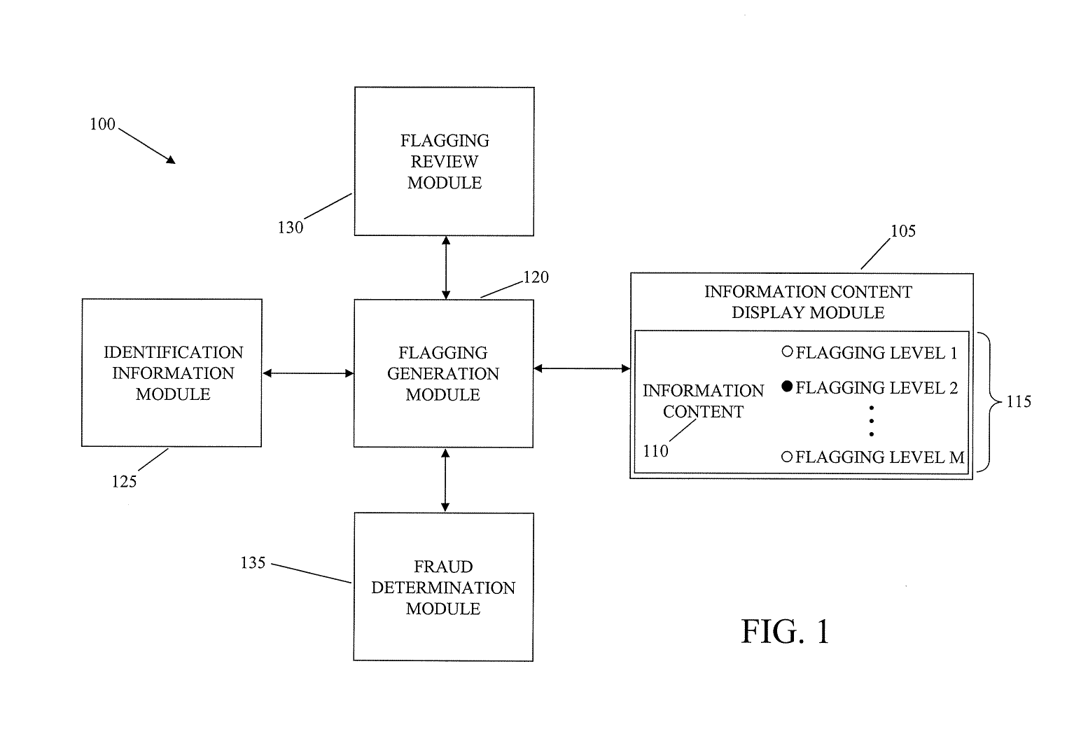

These and other aspects and embodiments of the present invention will now be described in greater detail. FIG. 1 is a block diagram illustrating a system 100 for flagging information content, in accordance with an exemplary embodiment of the present invention. As used herein, “information content” includes any suitable type of media, multimedia, or other information content that is capable of being viewed by, displayed or presented to, or otherwise accessed by users, including information available via the World Wide Web or Internet, or that which can be delivered over any suitable distribution channel (e.g., mobile/wireless, broadcast, retail, and other like channels). For example, information content can include such media as books or DVDs, digital music tracks, digital photos (e.g., camera-phone snapshots that can be sent over a mobile carrier network), and any other like information content.

The system 100 includes an information content display module 105. The information content display module 105 is configured to display information content 11 and an associated plurality of flagging levels 115 to users. The plurality of flagging levels 115 are configured for flagging the information content 11 by the users. According to exemplary embodiments, any suitable number and type of flagging levels 115 can be used for flagging the information content (e.g., flagging level 1, flagging level 2, flagging level 3, . . . , flagging level M, where M can be any appropriate number). The information content display module 105 can provide the graphical and/or textual interface through which the users or flaggers interact with the system 100 to flag the information content 110. For example, the information content display module 105 can be configured to display the information content 110 and flagging levels 115 through a suitable Web browser (e.g., Internet Explorer, Netscape Navigator, Firefox, Safari, Opera, or any other suitable Web browser) on a computer monitor or other appropriate display device, whether portable or (substantially) fixed.

According to exemplary embodiments, every item or piece of information content 110 (e.g., each webpage or individual items contained within each webpage) or collection thereof or other user-generated information content 110 can have a link or button allowing users to “flag” that piece of information content 110 for specific violations of, for example, rules of member conduct or other guidelines or content requirements. However, the information content display module 105 can display or otherwise present the list of various flags to the user/flagger in any suitable manner for selection (e.g., via a pull-down or pop-up menu displayed or otherwise associated with the piece(s) of information content 110). For purposes of illustration and not limitation, such flags can include, but are not limited to: Malicious Impersonation; Hijacked Account; Spam; Adult Content; and the like. The list of specific flags can change over time to reflect changes to content guidelines or other requirements or social/moral/community norms or standards. Additionally or alternatively, the list of flags can also include positive flags including, but not limited to: Best of <website name>—Funny; Best of <website name>—Thoughtful; and the like. Exemplary embodiments of the present invention can support any number and kind of individual flags, and these flags can be modified at any time.

The system 100 includes a flagging generation module 120 in communication with the information content display module 105. The flagging generation module 120 is configured to receive flags assigned by the users to the information content 110 in accordance with the plurality of flagging levels 115. The flagging generation module 120 is configured to assign a weight to each user flagging in accordance with the accuracy of the user flagging. The flagging generation module 120 is further configured to prioritize flagged information content 110 for review in accordance with the volume of flags assigned to the information content 110 and the flagging weight of each user flagging. In other words, if a large number of flags have been assigned to a particular item or piece of information content 110 and the majority of those flags have a high (or higher) flagging weight (as discussed below), then the flagging generation module 120 can assign a higher priority to the given item of information content 110 than that assigned to pieces of information content 110 that have fewer assigned flags and/or the majority of the flagging weight of those flags is low (or lower). With a higher priority or rank, the particular piece of information content 110 can be reviewed before other pieces of information content 110.

For each flag made by a registered, signed-in member of a website or other user who is known or otherwise identifiable, the system 100 according to exemplary embodiments can gather, capture, record or otherwise store any suitable type of identifying information. In other words, each flag submitted by each user can be associated with identifying information of the (known) user. For example, the identifying information can include, but is not limited to, any combination of the following: the date/time at which the flagging occurred; the specific flag selected; the Uniform Resource Locator (URL) of the flagged information content 110 (e.g., the network link to a webpage or the like); the unique member ID or other identifier of the flagee (i.e., the user who created and “owns” the flagged information content 110); the unique member ID or other identifier of the flagger (i.e., the user performing the flagging); the IP address of the flagger; and other like identifying information. Accordingly, the system 100 can include an identification information module 125 in communication with the flagging generation module 120. The identification information module 125 can be configured to capture (e.g., record or otherwise store) the identifying information associated with the user upon flagging of the information content 110 by the user. For each flag made by a user who is not signed-in or who is otherwise unidentified or unknown (i.e., an “anonymous user”), the identification information module 125 can record any or all the information as described above, except for such information as, for example, the unique member ID of the flagger (e.g., because it is not known at the time of the flagging).

According to exemplary embodiments, the flagging generation module 120 can be configured to group flags for common information content 110. For example, for the URL of the flagged information content 110, some pieces of content may be accessible through multiple, distinct URLs. These URLs, however, share a core link structure that identifies the unique piece of information content 110. In these cases, to group all flags for the same piece of information content 110, the shared core link structure can be treated by the flagging generation module 120 as the “URL of the flagged information content 110,” rather than the full or complete URLs. For example, each of the following links represents the same piece of content on an exemplary Xanga.com website:
http://www.xanga.com/marc/468725905/photo-xanga.html?nextdate=1033252614&direction-n#viewcomments
http://www.xanga.com/marc/468725905/photo-xanga.html?nextdate=last&direction=n#viewcomments
http://www.xanga.com/marc/468725905/photo-xanga.html
   According to exemplary embodiments, if a user visited each of the above links and flagged the information content 110 separately, the flagging generation module 120 would treat the flagging as three attempts to flag the same piece of content, identifiable by the shared core link structure of the URLs, i.e., http://www.xanga.com/marc/468725905/photo-xanga.html. Accordingly, the flagging generation module 120 can be configured to parse or otherwise evaluate the URLs or other like network links of the information content 110 to determine whether the links share such a core link structure. The flagging generation module 120 can maintain or otherwise store a record of such core link structures for purposes of evaluating subsequently received URLs or other like links.

According to an exemplary embodiment, the flagging generation module 120 can be configured to identify information content 110 using information contained in the network link of the information content 110. More particularly, individual items of information content 110 can be identified using information contained in the URL. For purposes of illustration and not limitation, the following URL is used as an example:
http://photo.xanga.com/marc/a010146775464/photo.html
   In such a URL, the “photo.html” at the end identifies the item as an individual photo (as opposed to a video, weblog entry, or other content). The username “marc” identifies that the photo is located on Marc's website. The string of alphanumeric characters immediately after the username (i.e., “a010146775464”) identifies which specific photo is being referenced. Accordingly, the flagging generation module 120 can be configured to parse or otherwise evaluate the network link (e.g., URL) of the information content 110 to identify the information content 110 (in the previous example, the photo “a010146775464” on Marc's website). Those of ordinary skill in the art will recognize that other suitable methods of identifying individual items of information content 110, particularly from network link information, can alternatively be used.

According to an exemplary embodiment, the user can assign at least one flag to the information content 110. Merely for purposes of illustration and not limitation, users can choose one specific flag per page of information content 110. For example, when a known user flags an item of information content 110, the most recent flag by that user (if any) for that particular item of information content 110 can be displayed to the user via the information content display module 105. The user can then click or otherwise select to undo that particular flag or choose a separate flag, but the user would not choose multiple flags for the given item of information content 110. In other words, according to one exemplary embodiment, the current flag assignment to the information content 110 by the user can replace the previous flag assignment to the same information content 110 by the same user, such that each user is able to assign one flag to each piece of information content 110. However, according to an alternative exemplary embodiment, multiple or compound flags can be assigned to each and any item of information content 110 by any user.

According to an additional exemplary embodiment, users do not flag information content 110 on their own websites or information content 110 that is otherwise authored or owned by the user. The flagging generation module 120 can be configured to ignore the user flagging of information content 110 associated with the user when prioritizing flagged information content 110 for review. In other words, although it may appear to the users that they are flagging their own information content 110, such flags can be ignored when prioritizing flagged information content 110 for review.

According to an exemplary embodiment, the flagging generation module 120 can be configured to utilize a combination of flagging information as a single flag when prioritizing flagged information content 110 for review. For example, the flagging information can comprise one or more of the following: the flag designation; the network link of the information content 110 being flagged; and the network address of the user performing the flagging. For purposes of illustration and not limitation, any unique combination of the following three elements can be treated as a single flag: the specific flag selected; the URL of the flagged information content 110; and the IP Address of the flagger. However, other additional and/or alternative elements can be used for a flag, and any suitable number and combination of such elements can be treated as a single flag by the flagging generation module 120. The flagging generation module 120 can record the number of repeated instances of any such combination, but it can treat all such instances collectively as a single flag when prioritizing flagged information content 110 for review.

According to exemplary embodiments, the review of the prioritized flagged information content 110 can be performed by designated moderators or automatically by the system 100. For example, the flagging system 100 can aggregate flagged information content 110 into a separate graphical user interface (or other suitable means of displaying graphical and/or textual information) where such information content 110 can be reviewed and processed by designated moderators. Accordingly, the information content display module 105 can be configured to aggregate and display the prioritized flagged information content 110 in such a user interface to facilitate review. Such an interface can be accessible (e.g., via a remote connection) by those moderators. The designated moderators can include, for example, employees of the information content provider, qualified members from the community, and other such individuals and members.

Additionally or alternatively, the system 100 can include a flagging review module 130 in communication with the flagging generation module 120. The flagging review module 130 can be configured to review the prioritized flagged information content 110 to determine the accuracy of the flags assigned by the users. For example, each piece of information content 110 can be automatically analyzed by suitable computer algorithms to determine whether the corresponding flag is accurate. For example, text content can be parsed for profanity and other words that tend to be associated with content appropriate for a mature audience. Photographic or video content can be analyzed for telltale signs of adult content (e.g., high prevalence of skintone colors, and the like) using suitable image processing algorithms. For purposes of illustration and not limitation, suppose a piece of (photographic) information content 110 has been flagged by one or more users as “Adult Content.” If telltale signs of adult content have been detected by the flagging review module 130, then the flag(s) can be indicated as being accurate. It is noted that some computerized analysis of multimedia content could over-report the likelihood of adult content (e.g., baby photos could be flagged as potentially being adult, due to the high prevalence of skin tones). As a result, modifications to flagging weights in accordance with such multimedia algorithms can vary according to their effectiveness for a given author, as opposed to being weighted according to their effectiveness across all authors. In such a manner, a flagger who tends to flag baby photos can have their flagging weight remain unmodified or increased as a result of the use of any multimedia algorithms, since historically (for that flagger) the computerized multimedia algorithm may not be accurately predicting the appearance of adult content.

If a moderator and/or the flagging review module 130 finds information content 110 to be flagged appropriately, the moderator and/or flagging review module 130 can mark the information content 110 as such (and all individual instances of that specific flag for that specific information content 110 can be marked as “Correct” or other like suitable designation). If a moderator and/or the flagging review module 130 finds information content 110 to be flagged inappropriately, the moderator and/or flagging review module 130 can mark the information content 110 as such (and all individual instances of that flag are marked as “Incorrect” or other like suitable designation). Moderators and/or the flagging review module 130 can also mark flagged information content 110 as “Resolved” (or other like suitable designation) without specifying whether the flags are “Correct” or “Incorrect.” Other alternative or additional identifiers or designations can be used to designate the flags during review. Thus, the flagging review module 130 can be configured to designate the flag with a first designation (e.g., “Correct” or the like) upon determination that the information content 110 is flagged correctly. The flagging review module 130 can also be configured to designate the flag with a second designation (e.g., “Incorrect” or the like) upon determination that the information content 110 is flagged incorrectly.

As discussed previously, the system 100 according to exemplary embodiments can prioritize flagged information content 110 for review based on the volume of flags and the flagging weight of the individual flaggers. The flagging weight for each user can be determined by the flagging generation module 120 in any suitable manner. The flagging weights for known user can be different than for anonymous users, although the assignment of flagging weights to both known and anonymous users can be performed in a similar or substantially similar manner. For purposes of illustration and not limitation, to determine the flagging weight for signed-in or otherwise known or identified users, the following procedure can be used:
Every known user starts with a predetermined weight of X (e.g., X=1 or any other suitable value).
For every “Correct” flag (discussed above), the user's flagging weight increases by Y (e.g., Y=5 or any other suitable value).
For every “Incorrect” flag (discussed above), the user's flagging weight decreases by Z (e.g., it is cut in half or decreased by any other suitable value).
For every “Resolved” flag (discussed above), the user's flagging weight is unchanged.

For purposes of illustration and not limitation, to determine flagging weight for anonymous users, the following procedure can be used. For weighting purposes, all flags made within a specific timeframe (e.g., 30 minutes or any other suitable timeframe) from a specific IP address can be treated as flags from the same anonymous user.
Every flag by anonymous users receives an initial flagging weight of R (e.g., R=1 or any other suitable value).
For every “Correct” flag, the user's flagging weight increases by S (e.g., S=1 or any other suitable value).
For every “Incorrect” flag, the user's flagging weight decreases by T (e.g., T=2 or any other suitable value).
For every “Resolved” flag, the user's flagging weight is unchanged.
   Thus, if a piece of information content 110 has been flagged with a large number of flags and at least a majority of those flags are accurate (e.g., “Correct”) or otherwise have a high flagging weight (e.g., above a suitable predetermined threshold), then the flagging generation module 120 can increase the priority of that information content 110 so that the content is further reviewed and processed before other pieces. Alternatively, if a piece of information content 110 has been flagged with a low number of flags and/or at least a majority of those flags are inaccurate (e.g., “Incorrect”) or otherwise have a log flagging weight (e.g., below a suitable predetermined threshold), then the flagging generation module 120 can decrease the priority of that information content 110 so that the content is reviewed and processed after other pieces with higher priority.

Thus, according to exemplary embodiments, the flagging generation module 120 can be configured to increase the flagging weight of the user upon determination that the user correctly flagged the information content 110. For example, the flagging weight can be increased by a first amount for known users and increased by a second amount for anonymous users. The flagging generation module can be configured to decrease the flagging weight of the user upon determination that the user incorrectly flagged the information content 110. For example, the flagging weight can be decreased by a first amount for known users and decreased by a second amount for anonymous users. However, as discussed previously, the flagging weight for both known and anonymous users can be increased/decreased by the same amount for correct/incorrect flagging. To prevent any single user from becoming too “powerful” with respect to their associated flagging weight (i.e., achieving a very high flagging weight), the flagging generation module 120 can be configured to apply a predetermined function to the flagging weight of each user when prioritizing information content 110 for review. For example, according to an exemplary embodiment, the square root of a user's flagging weight can be used when prioritizing content for review. However, any suitable method, means or algorithm can be used to prevent any single user from becoming too “powerful” (e.g., reducing the amount of each increase of a user's flagging weight when the user's total flagging weight reaches a certain threshold).

According to exemplary embodiments, changes to a user's flagging weight can trigger a re-prioritization of any remaining content already flagged by that user (i.e., flagged content that has not already been marked as “Correct,” “Incorrect,” or “Resolved” by a moderator and/or the flagging review module 130). Consequently, any change in the flagging weight of the user can be configured to cause the flagging generation module 120 to re-prioritize information content 110 not yet reviewed that has been flagged by the user. Such a change can also impact the prioritization of any information content 110 subsequently flagged by that user.

Thus, according to exemplary embodiments, as a user flags more information content 110, the flagging weight associated with that user's flaggings can be increased or decreased over time depending on the accuracy (or inaccuracy) of the user's flaggings. By maintaining such a “history” of the accuracy (or inaccuracy) of the user's flaggings, the flaggings of users who provide more accurate flaggings over time can be given greater weight than the users who provide less accurate or inaccurate flaggings. Such historical flagging accuracy can be used to combat flagging fraud in the system 100.

According to exemplary embodiments, the system 100 can reduce or eliminate incidences of or attempts at fraudulent flagging. The system 100 can include a fraud determination module 135 in communication with the flagging generating module 120. The fraud determination module 130 can be configured to screen each user flagging for fraud in accordance with the accuracy of the user flagging. For example, if a user has been consistently flagging information content 110 incorrectly (so that their associated flagging rate is low), then subsequent flags assigned by that user that are also determined to be incorrect can be marked or otherwise indicated as potentially fraudulent (as the user has demonstrated a history of incorrect flagging). The flagging generation module 120 can be configured to decrease the weight assigned to the user flagging when the user flagging is determined to be fraudulent by the fraud determination module 135. In such a manner, fraudulent flaggers can be quickly detected and given a weight so low as to be effectively ignored by the system 100. As the user makes more correct or otherwise accurate flaggings over time, the user's flagging weight can increase to the point that the user's flaggings are no longer considered fraudulent or potentially fraudulent.

Other suitable adjustments to the flagging weight can be made as needed by the flagging generation module 120 to improve the resistance to fraudulent flaggings. For example, if certain new flaggers (e.g., a new member, an IP address that has never been used to flag a piece of content before, or the like) are believed to be more likely to be fraudulent, their flagging weights can be adjusted downward on a percentage or other suitable basis. According to an additional exemplary embodiment, the flagging generation module 120 can be configured to modify the weight assigned to the user flagging in accordance with the length of time that the user has been performing flaggings. For example, new flaggers can have their flaggings multiplied by a fraction representing their “age” at the time of the flagging, divided by the number of days before the flagger is considered to be a valid flagger. For purposes of illustration and not limitation, suppose that flaggers are not considered valid until 7 days after their first flagging. If a new member flagged a piece of content at time zero, their flagging weight would be multiplied by 0/7, or 0. If a new member flagged a piece of content at day 1, their flagging weight would be multiplied by 1/7, or approximately 0.14. Once the flagger is considered “valid,” such age- or time-based weighting can be removed for that flagger.

According to an alternative exemplary embodiment, rather than assigning a variable weight to each user/flagger, each user flagging can be assigned a weight based on a predetermined binary (or other fixed) set of conditions in which one condition would cause the flagging weight to equal zero, and the other would cause the flagging weight to be one. For example, all trusted flaggers can have a flagging weight of one, and all other flaggers can have a flagging weight of zero. The level or threshold at which a flagger becomes “trusted” will depend on various factors, including, for example, the historical accuracy demonstrated by such users, the “age” of such users (as described above), and other like factors. However, it is noted that the flagging weight assigned to each flagger would not affect whether the information content 110 is (eventually) reviewed by a moderator. Rather, such weighting would merely affect the review priority given to such flagged information content 110.

Those of ordinary skill in the art will recognize that each of the modules of the system 100 can be located locally to or remotely from each other, while use of the system 100 as a whole still occurs within a given country, such as the United States. For example, merely for purposes of illustration and not limitation, the flagging generation module 120, the identification information module 125, the flagging review module 130, and the fraud determination module 130 (or any combination of such modules) can be located extraterritorially to the United States (e.g., in Canada and/or in one or more other foreign countries). However, the information content display module 105 can be located within the United States, such that the control of the system 100 as a whole is exercised and beneficial use of the system 100 is obtained by the user within the United States.

Each of modules of the system 100, including information content display module 105, the flagging generation module 120, the identification information module 125, the flagging review module 130, and the fraud determination module 130, or any combination thereof, can be comprised of any suitable type of electrical or electronic component or device that is capable of performing the functions associated with the respective element. According to such an exemplary embodiment, each component or device can be in communication with another component or device using any appropriate type of electrical connection that is capable of carrying (e.g., electrical) information. Alternatively, each of the modules of the system 100 can be comprised of any combination of hardware, firmware and software that is capable of performing the functions associated with the respective module.

Alternatively, the system 100 can be comprised of one or more microprocessors and associated memory(ies) that store the steps of a computer program to perform the functions of any or all of the modules of the system 100. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of any or all of the modules of the system 100. For example, the actual source code or object code of the computer program can be stored in the memory.

The system 100 can include suitable additional modules as necessary to assist or augment the functionality of any or all of the modules of the system 100. For example, the system 100 can include a database module that can be in communication with, for example, the flagging generation module 120. Such a database module can be configured to store any suitable type of information generated or used by or with the system 100, including, for example, flagging information (including weights applied to user flaggings), identification information of the users, information content 110, and other like information. Such a database module can be comprised of any suitable type of computer-readable or other computer storage medium capable of storing information in electrical or electronic form.

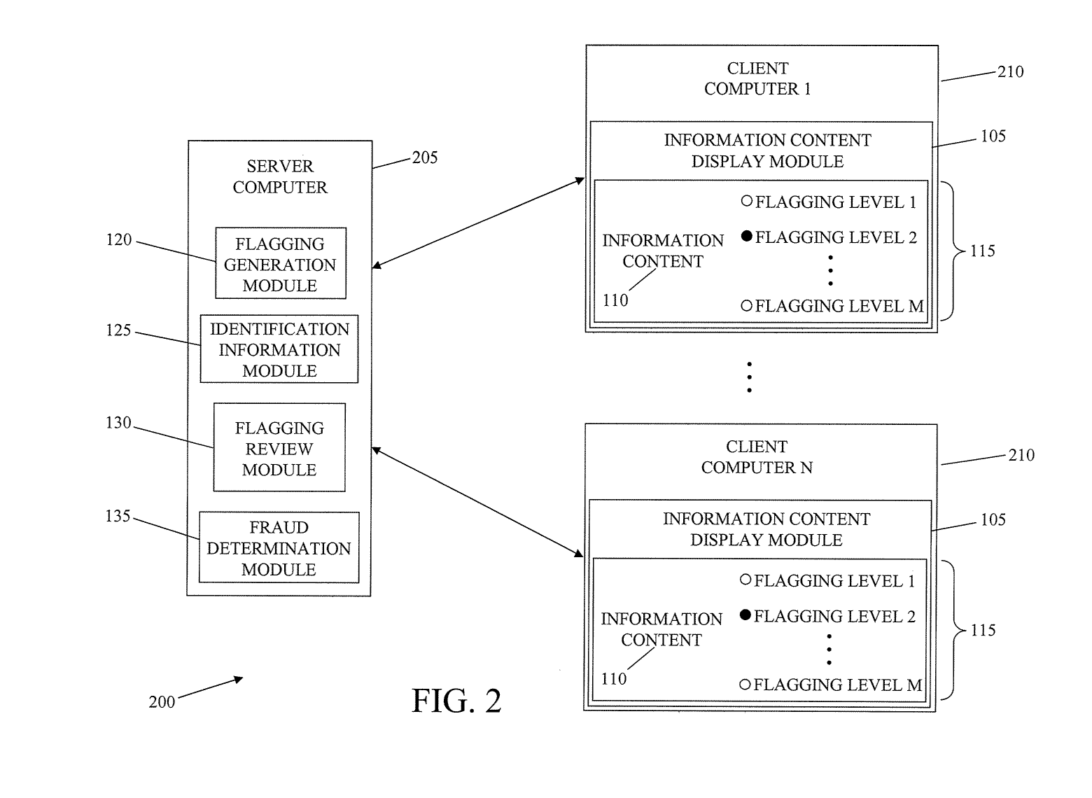

Alternative architectures or structures can be used to implement the various functions of the system 100 as described herein. For example, functions from two or more modules can be implemented in a single module, or functions from one module can be distributed among several different modules. FIG. 2 is a block diagram illustrating a decentralized system 200 for flagging information content, in accordance with an alternative exemplary embodiment of the present invention.

The system 200 includes a server computer 205 and a plurality of client computers 210 in communication with the server computer 205. The server computer 205 can comprise any suitable type of server computer, workstation, or the like that is capable of communicating with, coordinating, and servicing requests from numerous, remote clients. Each of the client computers 210 can comprise any suitable type of general purpose computer, PC, portable device (e.g., PDA) or the like capable of displaying the information content 110 and the plurality of flagging levels 15 to the user and allowing the user to interact with the system 200. Any suitable number of client computers 210 (e.g., client computer 1, client computer 2, . . . , client computer N, where N is any appropriate number) can be in communication with server computer 205. The server computer 205 is configured to cause the display, on at least one of the plurality of client computers 210, of the information content 110 and the plurality of flagging levels 115 for flagging the information content 110 by users. For example, the server computer 205 can communicate with the information content display module 105 (discussed previously) that can reside on each client computer 210 to cause the display of such information. Users on client computers 210 assign one of the plurality of flagging levels 115 to the information content 110. The server computer 205 is configured to assign a weight to each user flagging in accordance with an accuracy of the user flagging (e.g., using the flagging generation module 120 in the manner described previously). The server computer 205 is further configured to prioritize flagged information content 110 for review in accordance with the volume of flags assigned to the information content 110 and the flagging weight of each user flagging (e.g., using the flagging generation module 120 in the manner described previously).

Each flag submitted by each user can be associated with identifying information of the user. According to the present alternative exemplary embodiment, the server computer 205 can be configured to capture the identifying information associated with the user upon flagging of the information content 110 (e.g., using the identification information module 125 in the manner described previously). The server computer 205 can be configured to group flags for common information content 110. Additionally, the server computer 205 can be configured to identify information content 110 using information contained in the network link of the information content 110. For example, the server computer 205 can be configured to parse the network link of the information content 110 to identify the information content 110 (e.g., using the flagging generation module 120 in the manner described previously). The user can assign one or more flags to the information content 110. For example, the current flag assignment to the information content 110 by the user can replace the previous flag assignment to the same information content 110 by the same user. When prioritizing flagged information content 110 for review, the server computer 205 can be configured to ignore the user flagging of information content 110 of the user. The server computer 205 can be further configured to utilize a combination of flagging information as a single flag when prioritizing flagged information content 110 for review. For example, the flagging information can comprise one or more of the flag designation, the network link of the information content 110 being flagged, and the network address of the user performing the flagging.

According to the present alternative exemplary embodiment, the server computer 205 can be configured to aggregate prioritized flagged information content 110 for display via a user interface of the client computers 210 to facilitate review (e.g., using the information content display modules 105 in the manner described previously). The server computer 205 can also be configured to review the prioritized flagged information content 110 to determine the accuracy of the flags assigned by the users (e.g., using the flagging review module 130 in the manner described previously). For example, the server computer 205 can be configured to designate the flag with a first designation upon determination that the information content 110 is flagged correctly, and to designate the flag with a second designation upon determination that the information content 110 is flagged incorrectly. The server computer 205 can be configured to increase the flagging weight of the user upon determination that the user correctly flagged the information content 110. For example, the flagging weight can be increased by a first amount for known users and increased by a second amount for anonymous users. The server computer 205 can be configured to decrease the flagging weight of the user upon determination that the user incorrectly flagged the information content 110. For example, the flagging weight can be decreased by a first amount for known users and decreased by a second amount for anonymous users. A change in the flagging weight of the user can cause the server computer 205 to re-prioritize information content 110 not yet reviewed that has been flagged by the user. Additionally, the server computer 205 can be configured to apply a predetermined function to the flagging weight of each user when prioritizing information content 110 for review (e.g., using the flagging generation module 120 in the manner described previously).

To reduce or eliminate incidences of or attempts at fraudulent flagging, the server computer 205 can be configured to screen each user flagging for fraud in accordance with the accuracy of the user flagging (e.g., using the fraud determination module 135 in the manner described previously). For example, the server computer 205 can be configured to decrease the weight assigned to the user flagging when the user flagging is determined to be fraudulent. Other alternative architectures or structures can be used to implement the various functions of the systems 100 and 200 as described herein.

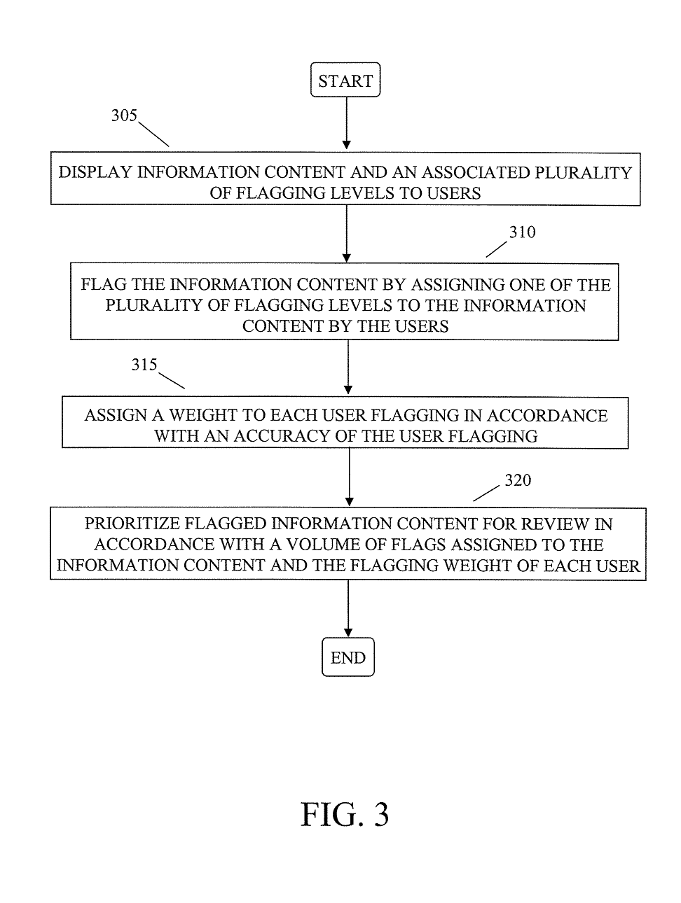

FIG. 3 is a flowchart illustrating steps for flagging information content, in accordance with an exemplary embodiment of the present invention. In step 305, the information content and an associated plurality of flagging levels are displayed to users. In step 310, the information content is flagged by assigning one of the plurality of flagging levels to the information content by the users. In step 315, a weight is assigned to each user flagging in accordance with the accuracy of the user flagging. In step 320, flagged information content is prioritized for review in accordance with the volume of flags assigned to the information content and the flagging weight of each user flagging.

According to an exemplary embodiment, each flag submitted by each user can be associated with identifying information of the user. The method can include the step of capturing the identifying information associated with the user upon flagging of the information content. As some pieces of information content may be accessible through multiple, distinct URLs or other network links, the method can include the step of grouping flags for common information content. In addition, the method can include the step of identifying information content using information contained in the network link of the information content. For example, the method can include the step of parsing or otherwise evaluating the network link of the information content to identify the information content.

According to an exemplary embodiment, the user can assign at least one flag to the information content. For example, the current flag assignment to the information content by the user can replace the previous flag assignment to the same information content by the same user. In addition, the method can include the step of ignoring the user flagging of information content of the user when prioritizing flagged information content for review. The method can also include the step of utilizing a combination of flagging information as a single flag when prioritizing flagged information content for review. For example, the flagging information can comprise at least one of the flag designation, the network link of the information content being flagged, and the network address of the user performing the flagging.

According to exemplary embodiments, the method can include the step of displaying prioritized flagged information content in a user interface to facilitate review. The method can further include the step of reviewing the prioritized flagged information content to determine the accuracy of the flags assigned by the users. For example, the method can include the steps of designating the flag with a first designation upon determination that the information content is flagged correctly, and designating the flag with a second designation upon determination that the information content is flagged incorrectly. The method can also include the step of increasing the flagging weight of the user upon determination that the user correctly flagged the information content. For example, the flagging weight can be increased by a first amount for known users and increased by a second amount for anonymous users. The method can include the step of decreasing the flagging weight of the user upon determination that the user incorrectly flagged the information content. For example, the flagging weight can be decreased by a first amount for known users and decreased by a second amount for anonymous users. According to an exemplary embodiment, a change in the flagging weight of the user can cause a re-prioritization of information content not yet reviewed that has been flagged by the user. Additionally or alternatively, the method can include the step of applying a predetermined function to the flagging weight of each user when prioritizing information content for review.

According to the present exemplary embodiment, incidents of fraudulent flagging can be reduced or eliminated by screening each user flagging for fraud in accordance with the accuracy of the user flagging. The weight assigned to the user flagging can be decreased when the user flagging is determined to be fraudulent.

Each, all or any combination of the steps of a computer program as illustrated in FIG. 3 for flagging information content can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any device, system or process to flag any suitable individual or collective information content, including information content other than Web or Internet content. More particularly, exemplary embodiments of the present invention can be used to flag any suitable item or items of information content that can be delivered over any suitable distribution channel (e.g., Internet, mobile/wireless, broadcast, retail, and other like channels). For example, exemplary embodiments can be used to flag products such as books or DVDs, to flag retail outlets such as restaurants, to flag digital music tracks (e.g., that are sold through retail outlets with or without the flags on them), to flag camera-phone snapshots that can be sent over a mobile carrier network carrying the appropriate flag(s), and the like. In addition, the flagging system according to exemplary embodiments can be used to re-flag previously screened information content, such as to re-flag old movies that have already been flagged by the MPAA or other reviewing body, to update those flaggings for modern community standards. Exemplary embodiments described herein can mitigate the issue of fraudulent flaggings given by users hoping to falsely increase (or decrease) the flagging of an item in which they have an interest (e.g., an author flagging their own book down on an online retailer site).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and patent applications, foreign patents and patent applications, and publications discussed above are hereby incorporated by reference herein in their entireties to the same extent as if each individual patent, patent application, or publication was specifically and individually indicated to be incorporated by reference in its entirety.

What is claimed is:

1. A system for flagging information content, comprising:
an information content display module,
wherein the information content display module is configured to display the information content and an associated plurality of flagging levels to users,
wherein the plurality of flagging levels are configured for flagging the information content by the users; and
a flagging generation module in communication with the information content display module,
wherein the flagging generation module is configured to receive flags assigned by the users to the information content in accordance with the plurality of flagging levels,
wherein the flagging generation module is configured to assign a weight to each user flagging in accordance with an accuracy of the user flagging, and
wherein the flagging generation module is configured to prioritize flagged information content for review in accordance with a volume of flags assigned to the information content and the flagging weight of each user flagging.

2. The system of claim 1, wherein each flag submitted by each user is associated with identifying information of the user.

3. The system of claim 2, comprising:
an identification information module in communication with the flagging generation module,
wherein the identification information module is configured to capture the identifying information associated with the user upon flagging of the information content.

4. The system of claim 1, wherein the flagging generation module is configured to group flags for common information content.

5. The system of claim 1, wherein the flagging generation module is configured to identify information content using information contained in the network link of the information content.

6. The system of claim 5, wherein the flagging generation module is configured to parse the network link of the information content to identify the information content.

7. The system of claim 1, wherein the user assigns at least one flag to the information content.

8. The system of claim 7, wherein a current flag assignment to the information content by the user replaces a previous flag assignment to the same information content by the same user.

9. The system of claim 1, wherein the flagging generation module is configured to ignore the user flagging of information content of the user when prioritizing flagged information content for review.

10. The system of claim 1, wherein the flagging generation module is configured to utilize a combination of flagging information as a single flag when prioritizing flagged information content for review.

11. The system of claim 10, wherein the flagging information comprises at least one of a flag designation, a network link of the information content being flagged, and a network address of the user performing the flagging.

12. The system of claim 1, wherein the information content display module is configured to aggregate and display prioritized flagged information content in a user interface to facilitate review.

13. The system of claim 1, comprising:
a flagging review module in communication with the flagging generation module,
wherein the flagging review module is configured to review the prioritized flagged information content to determine the accuracy of the flags assigned by the users.

14. The system of claim 13, wherein the flagging review module is configured to designate the flag with a first designation upon determination that the information content is flagged correctly, and
wherein the flagging review module is configured to designate the flag with a second designation upon determination that the information content is flagged incorrectly.

15. The system of claim 1, wherein the flagging generation module is configured to increase the flagging weight of the user upon determination that the user correctly flagged the information content.

16. The system of claim 15, wherein the flagging weight is increased by a first amount for known users and increased by a second amount for anonymous users.

17. The system of claim 1, wherein the flagging generation module is configured to decrease the flagging weight of the user upon determination that the user incorrectly flagged the information content.

18. The system of claim 17, wherein the flagging weight is decreased by a first amount for known users and decreased by a second amount for anonymous users.

19. The system of claim 1, wherein a change in the flagging weight of the user is configured to cause the flagging generation module to re-prioritize information content not yet reviewed that has been flagged by the user.

20. The system of claim 1, wherein the flagging generation module is configured to apply a predetermined function to the flagging weight of each user when prioritizing information content for review.

21. The system of claim 1, comprising:
a fraud determination module in communication with the flagging generation module,
wherein the fraud determination module is configured to screen each user flagging for fraud in accordance with the accuracy of the user flagging, and
wherein the flagging generation module is configured to decrease the weight assigned to the user flagging when the user flagging is determined to be fraudulent by the fraud determination module.

22. The system of claim 1, wherein the information content comprises World Wide Web content.

23. A method of flagging information content, comprising the steps of:
a.) displaying the information content and an associated plurality of flagging levels to users;
b.) flagging the information content by assigning one of the plurality of flagging levels to the information content by the users;
c.) assigning a weight to each user flagging in accordance with an accuracy of the user flagging; and
d.) prioritizing flagged information content for review in accordance with a volume of flags assigned to the information content and the flagging weight of each user flagging.

24. The method of claim 23, wherein each flag submitted by each user is associated with identifying information of the user.

25. The method of claim 24, comprising the step of:
e.) capturing the identifying information associated with the user upon flagging of the information content.

26. The method of claim 23, comprising the step of:
e.) grouping flags for common information content.

27. The method of claim 23, comprising the step of:
e.) identifying information content using information contained in the network link of the information content.

28. The method of claim 23, wherein a current flag assignment to the information content by the user replaces a previous flag assignment to the same information content by the same user.

29. The method of claim 23, comprising the step of:
e.) ignoring the user flagging of information content of the user when prioritizing flagged information content for review.

30. The method of claim 23, comprising the step of:
e.) utilizing a combination of flagging information as a single flag when prioritizing flagged information content for review.

31. The method of claim 30, wherein the flagging information comprises at least one of a flag designation, a network link of the information content being flagged, and a network address of the user performing the flagging.

32. The method of claim 23, comprising the step of:
e.) reviewing the prioritized flagged information content to determine the accuracy of the flags assigned by the users.

33. The method of claim 32, comprising the steps of:
f.) designating the flag with a first designation upon determination that the information content is flagged correctly; and
g.) designating the flag with a second designation upon determination that the information content is flagged incorrectly.

34. The method of claim 23, comprising the step of:
e.) increasing the flagging weight of the user upon determination that the user correctly flagged the information content.

35. The method of claim 34, wherein the flagging weight is increased by a first amount for known users and increased by a second amount for anonymous users.

36. The method of claim 23, comprising the step of:
e.) decreasing the flagging weight of the user upon determination that the user incorrectly flagged the information content.

37. The method of claim 36, wherein the flagging weight is decreased by a first amount for known users and decreased by a second amount for anonymous users.

38. The method of claim 23, comprising the step of:
e.) applying a predetermined function to the flagging weight of each user when prioritizing information content for review.

39. A decentralized system for flagging information content, comprising:
a server computer; and
a plurality of client computers in communication with the server computer,
wherein the server computer is configured to cause the display, on at least one of the plurality of client computers, of the information content and a plurality of flagging levels for flagging the information content by users,
wherein users on client computers assign one of the plurality of flagging levels to the information content,
wherein the server computer is configured to assign a weight to each user flagging in accordance with an accuracy of the user flagging, and
wherein the server computer is configured to prioritize flagged information content for review in accordance with a volume of flags assigned to the information content and the flagging weight of each user flagging.
